(19) United States
(12) Patent Application Publication
(10) Pub. No.: US 2014/0236791 A1
(43) Pub. Date: Aug. 21, 2014

(54) IMAGE RETRIEVAL AND TRANSACTION ID CAPTURE

(71) Applicant: BANK OF AMERICA CORPORATION, Charlotte, NC (US)

(72) Inventors: Craig David Palmer, Mint Hill, NC (US); Eric Scott Sandoz, Concord, CA (US); Michael Gerald Smith, Fort Mill, SC (US); Geoffrey Reed Williams, Midlothian, TX (US)

(73) Assignee: BANK OF AMERICA CORPORATION, Charlotte, NC (US)

(21) Appl. No.: 13/768,881

(22) Filed: Feb. 15, 2013

(51) Int. Cl. G06Q 40/02

(52) U.S. Cl. CPC G06Q 40/02
USPC 705/35

(57) ABSTRACT

Embodiments of the invention are directed to systems, methods and computer program products for providing image retrieval based on transaction identification. An exemplary apparatus is configured to: capture an image of a document. The document is typically associated with a transaction ID. Upon capturing the document image the system may process the image of the document to collect document information, and subsequently store the document information. The system may later receive a request for the document information that is similarly associated with the transaction ID. This document information is retrieved based at least partially on the request. An activity log may be additionally created which comprises a record of one or more request associated with the transaction ID.

### BACKGROUND

Financial institutions typically save data related to documents or document images for use in later retrieving document information. Retrieving a document image can result in the original document image being recreated and stored in memory each time a document image is requested. This type of archiving process can then result in an excessive use of storage space, which reduces the efficiency of the financial institutions resources. Therefore, there is a need for an image retrieval system that archives and retrieves document images in a way that eliminates the excessive use of storage space for duplications of identical documents.

### BRIEF SUMMARY

Embodiments of the invention are directed to systems, methods, and computer program products for providing image retrieval associated with a transaction ID. In some embodiments, the system may comprise an apparatus for providing image retrieval based on transaction identification. The apparatus may comprise several components, including but not limited to, a memory, a processor, and a module stored in the memory, executable by the processor, and configured to perform a plurality of method steps.

In some embodiments, the module is configured to capture an image of a document. The document image or the document itself may additionally be associated with a transaction ID, which may be indicated in the original document or determined by the system in response to capturing the document image. In some embodiments, the transaction ID is determined after the initial capture of the image of the document. In some embodiment, capturing the image of the document further comprises converting the document type to a predetermined electronic format.

The module is further configured to process the image of the document to collect document information and subsequently store the document information. In some embodiments, the system may receive a request for the document information. The request may be additionally associated with the transaction ID of the document. In some embodiment, receiving a request for the document information further comprises determining a request ID to be associated with the request for the document information.

Based at least partially on the request, the system may retrieve the requested document information. In some embodiments, the system may be further configured to create a pointer which references the document information. In such an embodiment, the document information may be retrieved by referencing the pointer and generating a temporary image which displays the document information. In some embodiments, retrieving the document information comprises retrieving a portion of the document information. To this extent, the request may indicate that only a portion of the document information be retrieved versus retrieving the entire document. In some embodiments, the module is further configured to create an activity log. The activity log may comprise one or more request associated with the transaction ID.

The system may additionally include a computer program product for providing image retrieval based on transaction identification. The computer program product may comprise a non-transitory computer-readable medium comprising a set of codes for causing a computer to capture an image of a document. The document image or the document itself may additionally be associated with a transaction ID. In some embodiments the set of codes may cause the computer to determine the transaction ID in response to capturing the document image. The transaction ID may be determined based upon information in the document or randomly generated. In some embodiments, the transaction ID is determined after the initial capture of the image of the document. In some embodiments, the set of codes for causing a computer to capture the image of the document may be further configured to cause a computer to convert the document type to a predetermined electronic format.

The set of codes may be further configured to cause a computer to process the image of the document to collect document information. The set of codes may additionally cause a computer to store the collected document information. In some embodiments, the system may receive a request for the document information. The request may be additionally associated with the transaction ID of the document. In some embodiments, the set of codes for causing a computer to receive a request for the document information may be further configured to cause a computer to determine a request ID to be associated with the request for the document information.

The set of codes may be further configured to cause a computer to retrieve the requested document information based at least partially on the request. In some embodiments, the set of codes may be further configured to cause a computer to create a pointer which references the document information. In such an embodiment, the document information may be retrieved by referencing the pointer and generating a temporary image which displays the document information. In some embodiments, the set of codes for causing a computer to retrieve the document information are further configured to cause a computer to receive only a portion of the document information. To this extent, the request may indicate that only a portion of the document information be retrieved versus retrieving the entire document. In some embodiments, the set of codes is further configured to cause a computer to create an activity log. The activity log may comprise one or more request associated with the transaction ID.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### BRIEF DESCRIPTION OF THE DRAWINGS

Having thus described embodiments of the invention in general terms, reference will now be made to the accompanying drawings, where:

FIG. 1 is a flow chart illustrating a general process flow for processing a check, in accordance with embodiments of the present invention;

FIG. 2 is a diagram illustrating a system for providing image retrieval based on transaction identification, in accordance with embodiments of the present invention;

FIG. 3 is a diagram illustrating an exemplary check, in accordance with embodiments of the present invention;

FIG. 4 is a diagram illustrating a, in accordance with embodiments of the present invention;

FIG. 5 is a diagram illustrating an exemplary check, in accordance with embodiments of the present invention;

FIG. 6 is a flow chart illustrating a general process flow for providing image retrieval based on transaction identification, in accordance with embodiments of the present invention; and

FIG. 7 is a screen shot illustrating an activity log, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for providing image retrieval associated with a transaction ID. The invention enables an entity to capture an image of a document that is associated with a transaction ID, process the image of the document to collect document information, store the document information, receive a request for the document information, retrieve the document information based at least partially on the request, and create an activity log that comprises one or more request associated with the transaction ID.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded).

The present invention is centered on check imaging technology with a purpose of saving storage space in the archive of an entity (e.g., a financial institution). Currently, an entity's check imaging system may receive an image of a check at a high resolution (200 dots per inch (DPI)) and may store the image in the archive at this resolution for a mandated period of seven years. However, regulations may not require that the archived image be of this high resolution. To save storage space in the archive, the present invention may capture pieces of the check information by processing the image of the check and then store the various pieces of the check information as either text or smaller high resolution (or low resolution) images. The pieces of check information may then be retrieved individually or in bulk by an apparatus to generate a second image of the check. Furthermore, the present invention may create a thumbnail version of the image of the check at a lower resolution and store said thumbnail version of the image of the check in the archive for seven years in lieu of storing the high resolution image of the check. A check is an example of a document that may be captured or processed in this invention. As used herein, a “check” may also refer to a myriad of financial documents, including but not limited to a lease document, a mortgage document, a deposit slip, a payment coupon, a receipt, or the like. In some embodiments, the check may exist as a physical item printed on paper or other medium. In other embodiments, the check may exist electronically.

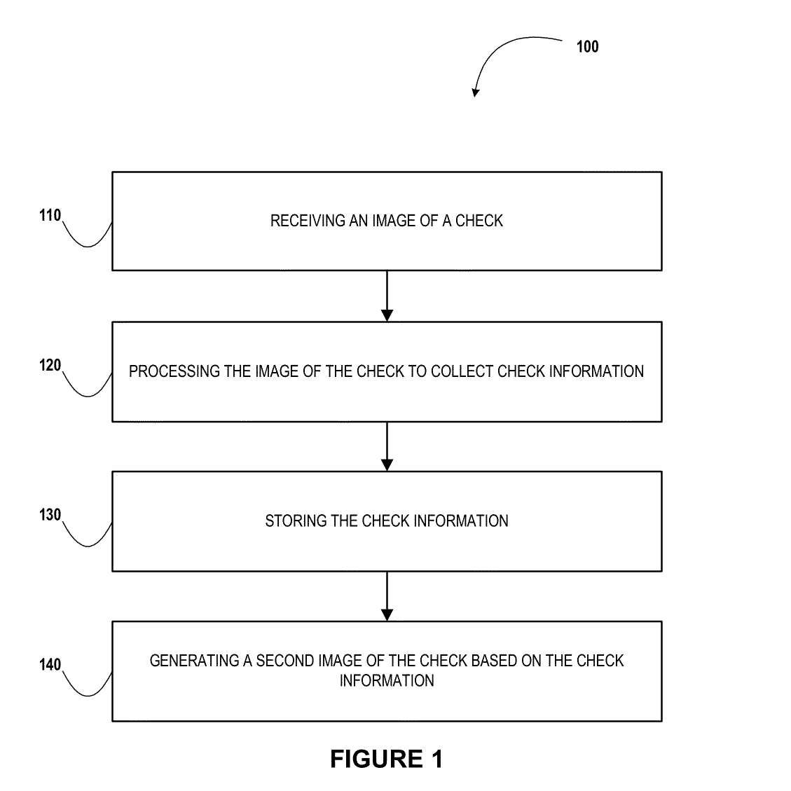

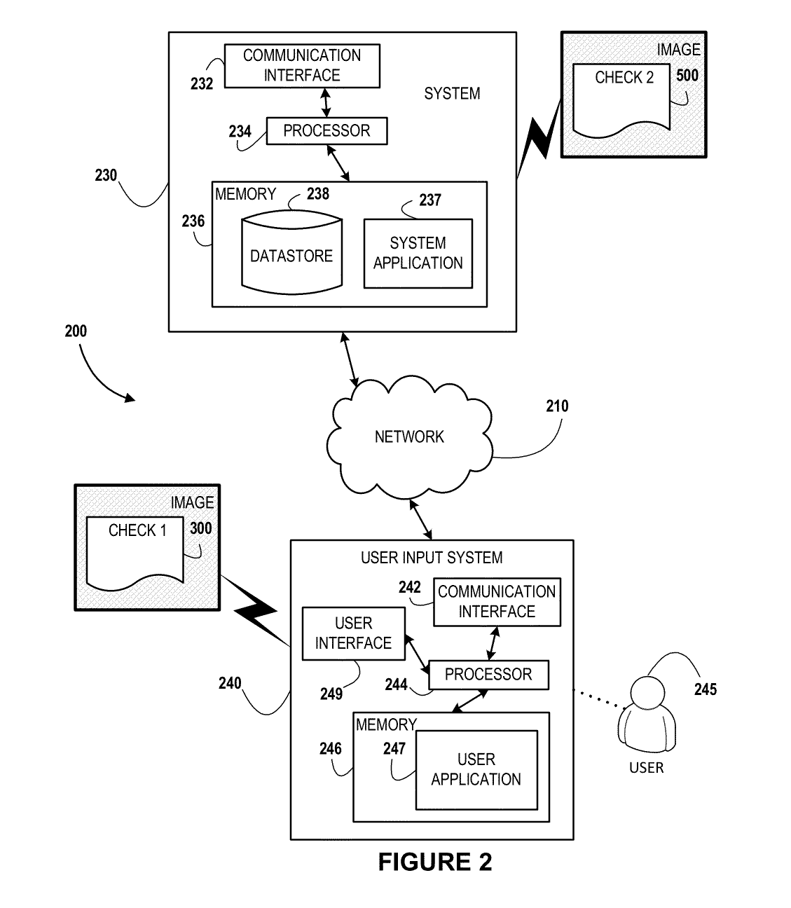

Referring now to FIG. 1, FIG. 1 presents a general process flow 100, in accordance with some embodiments of the invention. At block 110, the method comprises receiving an image of a check. In some embodiments, the image of the check may be received by an apparatus (e.g. a computer system) via a user's mobile device, a camera, an Automated Teller Machine (ATM) at one of the entity's facilities, a second apparatus at a teller's station, or the like. In other embodiments, the apparatus may be configured to capture the image of the check. An example of an apparatus that performs block 110 is the user input system 240 in FIG. 2.

At block 120, the method comprises processing the image of the check to collect check information. After the successful retrieval or capture of the image of the check, the apparatus may process the image of the check. The apparatus may capture individual pieces of check information from the image of the check. In some embodiments, the check information may be text. In other embodiments, the check information may be an image. Further processing enables the apparatus to create a thumbnail version (a resized smaller version) of the image of the check at a lower resolution. In some embodiments, the thumbnail version of the image of the check may be created substantially simultaneously to the capture of the image of the check. An example of the apparatus that performs block 120 is system 230 in FIG. 2.

At block 130, the method comprises storing the check information. After the image of the check is processed, the apparatus may store the collected check information. In some embodiments, the individual pieces of check information may be stored separately, and may be associated with each other via data or metadata. In some embodiments, the individual pieces of check information may be stored together. In some embodiments, the apparatus may additionally store the original image of the check immediately after the image of the check is received. Because the original high resolution image of the check must be held in storage for a 90 day period, the high resolution image of the check may be deleted 90 days (or any time thereafter) following its capture. In some embodiments, the apparatus may additionally store the thumbnail version of the image of the check. The entity may reserve the right to determine how to process and/or how long to store the check information, image of the check, and/or the thumbnail version of the check. An example of the apparatus that performs block 130 is system 230 in FIG. 2.

At block 140, the method comprises generating a second image of the check, based on the check information. If the user wishes to view the image of the check, the apparatus may generate a second image of the check based on the stored check information (text, images, or the like). In some embodiments, pieces of the check information may be requested individually. In these embodiments, pieces of the check information may be delivered individually based on the user's request. For example, if the user wishes to view just the check number, the apparatus may deliver to the user just the check number, not the entire image of the check. In other embodiments, multiple pieces of the check information may be retrieved. For example, if the user wishes to view an image of the entire check, the apparatus may retrieve multiple pieces of check information and produce for the user an image of the check. In some embodiments, the generated image of the check may accurately present the stored check information on a standard template (e.g. a check with a blank or plain background). The entity may reserve the right to determine the design or style of the template.

Referring now to FIG. 2, FIG. 2 presents an exemplary block diagram of the system environment 200 for implementing the process flow described in FIG. 1 in accordance with embodiments of the present invention. As illustrated, the system environment 200 includes a network 210, a system 230, and a user input system 240. Also shown in FIG. 2 is a user 245 of the user input system 240. The user input system 240 may be a mobile device described herein. The user 245 may be a person who uses the user input system 240 to execute a user application 247. The user application 247 may be an application to communicate with the system 230, perform a transaction, input information onto a user interface presented on the user input system 240, or the like. The user application 247 and/or the system application 237 may incorporate one or more parts of any process flow described herein.

As shown in FIG. 2, the system 230, and the user input system 240 are each operatively and selectively connected to the network 210, which may include one or more separate networks. In addition, the network 210 may include a telecommunication network, local area network (LAN), a wide area network (WAN), and/or a global area network (GAN), such as the Internet. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a tablet computing device, a network device, an ATM, a bank teller's equipment, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein. Specifically, the user application 247 executes the process flow described in FIG. 1, as well as any other process flow described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information. Additionally, the user input system 240 may include a positioning system. The positioning system (e.g., a global positing system GPS) may enable at least one of the user input system 240 or an external server or computing device in communication with the user input system 240 to determine the location (e.g., location coordinates) of the user input system 240.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols. In some embodiments, the user application 247 may be associated with a mobile device, wherein the mobile device executes a check deposit application. In some embodiments, the user application 247 may be associated with an ATM at one of the entity's facilities. Thus, the ATM may include a check imaging system wherein the check imaging system captures an image of the check. Following successful capture of the image of the check, the ATM may transmit the image to the system 230 for processing, storage, generation of an image of the check, or the like. In other embodiments, the user application 247 may interact with a bank teller, his equipment, a kiosk in the entity's facility, or the like associated with the entity.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be a server managed by the entity. The system 230 may be located at the facility associated with the entity or remotely from the facility associated with the entity. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols. In some embodiments, the system application 237 may include the processing of the image of Check 1 300 from which the system 230 may collect check information.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein. For example, the datastore 238 may store information associated with the user's account, check information, or the like. Further, the datastore 238 may comprise an archive, temporary storage locations, or the like.

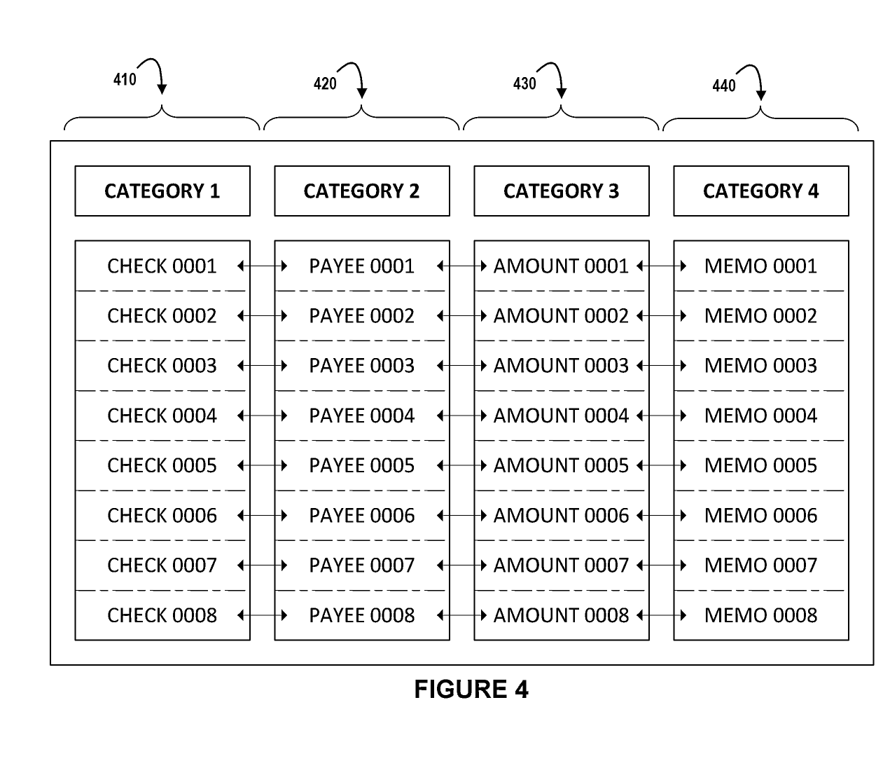

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current. FIG. 4 expresses the datastore 238 and its contents in more detail.

FIG. 2 also shows two check images that interact with the system environment 200. The image of Check 1 300 may be the image of the check that is received by the user input system 240. The user input system 240 may collect the check information from the image of Check 1 300. The image of Check 2 500 may be the image of the check that is generated by the system 230. The image of Check 2 500 may be generated based on the check information stored in the datastore 238. Both images of Check 1 300 and Check 2 500 may include an image of the entire check, a thumbnail version of the image of the check, individual pieces of check information, or the like.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of the process flows described and/or contemplated herein in connection any process flow described herein. Additionally, the system 230 or the user input system 240 is configured to initiate presentation of any of the user interfaces described herein. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software. As used herein, an apparatus may refer to at least one of the user input system 240 or the system 230.

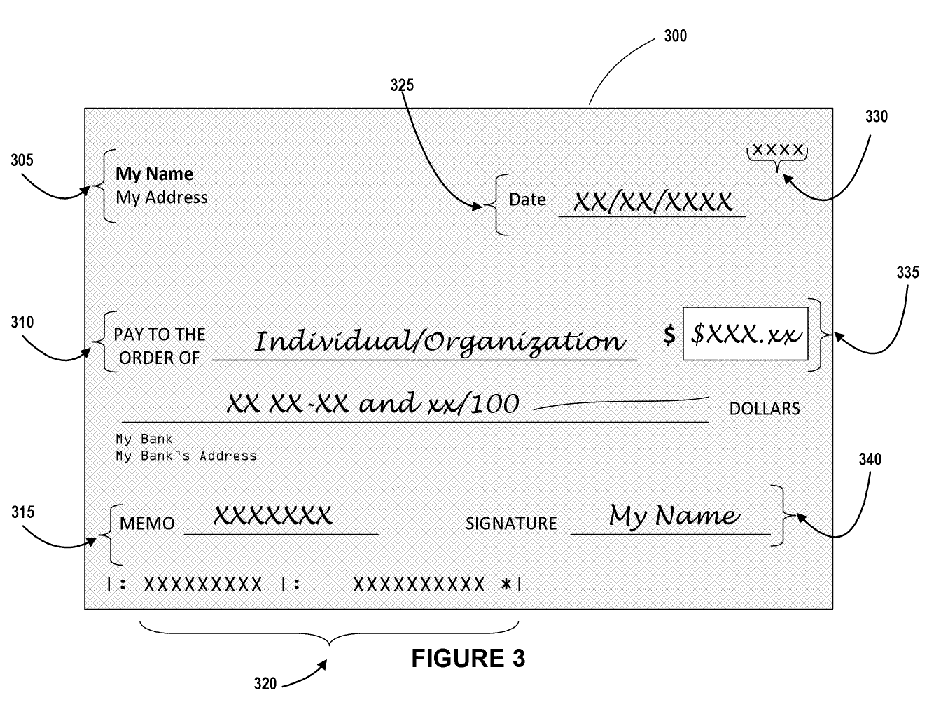

Now referring to FIG. 3, FIG. 3 illustrates an exemplary image of Check 1 300, the image of the check received by the user input system 240. The image of Check 1 300 may comprise an image of the entire check, a thumbnail version of the image of the check, individual pieces of check information, or the like. Check 1 300 comprises check information, wherein the check information comprises contact information 305, the payee 310, the memo description 315, the account number and routing number 320 associated with the appropriate user or customer account, the date 325, the check number 330, the amount of the check 335, the signature 340, or the like. In some embodiments, the check information may comprise text. In other embodiments, the check information may comprise an image. The user input system 240 may capture an image of Check 1 300 and transmit the image to the system 230 via a network. The system 230 may collect the check information from the image of Check 1 300 and store the check information in the datastore 238. In some embodiments, the pieces of check information may be stored in the datastore 238 individually. In other embodiments, multiple pieces of check information may be stored in the datastore 238 together. In some embodiments, the pieces of check information may be stored in the datastore 238 immediately following the capture of the image of Check 1 300. In other embodiments, the pieces of check information may be stored in the datastore 238 at a predetermined point in time after the image of Check 1 300 has been captured. The entity may reserve the right to determine the point in time in which the check information is stored in the datastore 238. In some embodiments, the check information may be captured or stored in the datastore 238 at a lower resolution than the original image of the check. In other embodiments, the check information may be captured or stored in the datastore 238 at a higher resolution than the original image of the check. In some embodiments, the check information may be captured or stored in the datastore 238 at a reduced size. In other embodiments, the check information may be captured or stored in the datastore 238 at an increased size.

Now referring to FIG. 4, FIG. 4 illustrates an example of the datastore 238. The system 230 may store the pieces of check information of the processed check in one or more datastores 238. In some embodiments, a datastore 238 may comprise at least one element of check information for multiple checks. For example, a datastore 238 may include check numbers (or payee names, check amounts, check dates, signatures, or the like) for multiple checks. In other embodiments, multiple checks may share a single datastore 238 for the storage of their check information. Items 410, 420, 430, and 440 represent categories of check information in the datastore 238. For example, categories of check information may include but are not limited to the check number, the payee, the amount of the check, the memo description, the contact information, the date, the signature, the account number and routing number, or the like. Further, associated pieces of check information for a single check may be linked with one another using data or metadata. For example, check number 0001 and payee name 0001 may be associated with each other for ease of access.

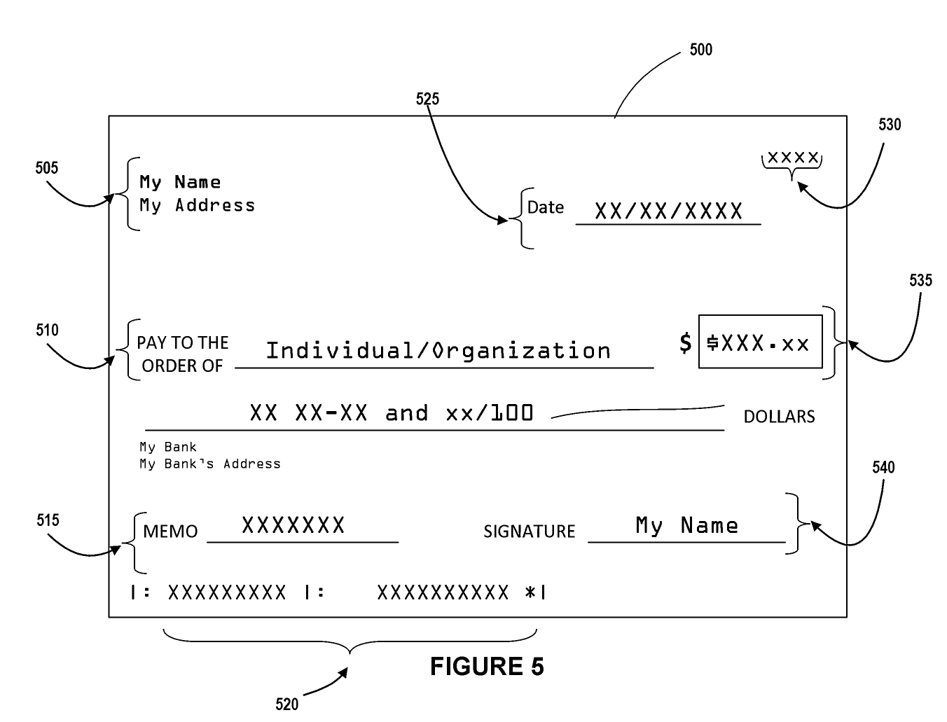

Referring now to FIG. 5, FIG. 5 illustrates the image of Check 2 500. The image of Check 2 500 comprises an image of the entire check, a thumbnail version of the image of the check, individual pieces of check information, or the like. The system 230 may retrieve the pieces of check information to generate a new image of Check 2 500. In some embodiments, the retrieved pieces of check information may be presented in the image of Check 2 500 at a lower resolution than the original image of the check. In other embodiments, the check information may be presented in the image of Check 2 500 at a higher resolution than the original image of the check. In some embodiments, the check information may be presented in the image of Check 2 500 at a reduced size. In other embodiments, the check information may be presented in the image of Check 2 500 at an increased size. Check 2 500 may comprise check information, wherein the check information may comprise contact information 505, the payee 510, the memo description 515, the account number and routing number 520 associated with the appropriate user or customer account, the date 525, the check number 530, the amount of the check 535, the signature 540, or the like.

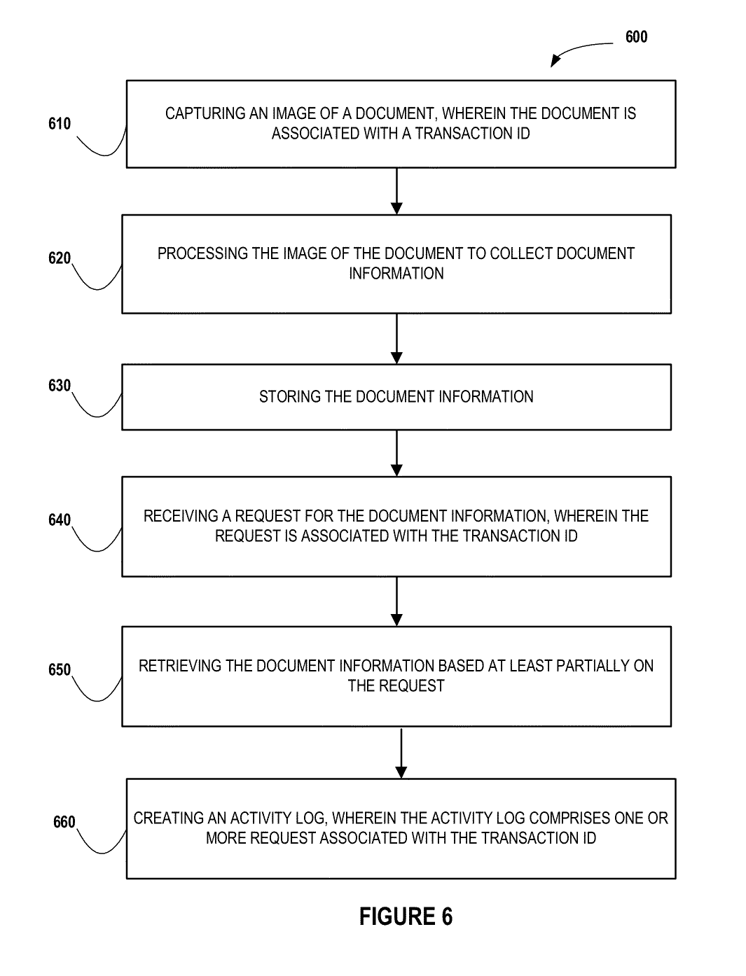

Referring now to FIG. 6, FIG. 6 presents a general process flow 600, in accordance with some embodiments of the invention. The general process flow 600 illustrates a method for retrieving an image and associating a transaction ID with the image retrieval. The method may comprise several steps including but not limited to capturing an image of a document, processing the image of the document to collect document information that is associated with a transaction ID, storing the collected document information, receiving a request for the document information, retrieving the document information based at least partially on the request, and creating an activity log that comprises a record of request associated with the transaction ID. The general process flow 600 is explained with greater detail below.

At block 610 the method comprises capturing a document image. Processed documents may include, but not be limited to, checks, deposit slips, withdrawal slips, loan documents, applications for credit approval, and the like. The document image may be captured in response to receiving a document from a user. The document image can be captured by a plurality of devices including, but not limited to, mobile devices, cameras, ATMs, scanning devices, a teller apparatus, or any combination of the aforementioned. For example, a user may initiate the deposit of a check using an automated teller machine. Upon receiving the physical check, the automated teller machine may capture an image of the check.

Document images may be captured in various ways dependent upon the type of document which is received. Documents may vary with respect to their page count, orientation, size and the like. For example, an image of a document with multiple pages may be captured by individually scanning each page of the document. This process may render several individual image files that can be subsequently combined after the initial capture of each individual page in order to generate a single document image. In such an embodiment, the document image may be embodied by a PDF file. Alternatively, an image of a single paged document can be captured by completing one successful scan of the document, which may render a JPEG file. Images for documents which have information displayed on the front and back side of the document can be captured such that both the front and back side of the document are accounted for during the image capture. For example, an image can be captured for the front and back of a check. In one embodiment, an image may be captured for both the front and back side of a check such that one image displaying both the front and back of the check in a single front page view is rendered.

In some embodiments, capturing the document image may comprise receiving a hard-copy of a document and converting to and/or generating an electronic version of the document. A physical and/or hard-copy of a document may be received using various devices. Electronic formats for document conversion and/or generation may include, but not be limited to, JPEG, TIFF, RAW, BMP, PNG, PDF, text file formats, and the like. For example, a user may initiate the deposit of a check using an automated teller machine. Upon receiving the physical check, the automated teller machine may convert the hard-copy to an electronic image such as a JPEG. In another example, a user may sign several loan documents while doing business with a financial institution. The financial institution may then scan the physical copy of the loan document such that the document is converted to a searchable PDF file. Alternatively, in some embodiments, the document is already in an electronic format when it is received. The document may still be converted to an alternative electronic format that is predetermined by the entity which receives the document. For example, a financial institution's system may be configured to process JPEG images. To this extent if a user emails the financial institution an electronic copy of a document in PDF form, the document can be converted to JPEG images in order to be processed by the financial institutions system.

Capturing the document image may further comprise uploading an electronic form of the document to a second device. The second device may be an apparatus that is separate and distinct from the device used to initially capture the image. In some embodiments, the second device is a device associated with an entity which processes the respective document. In one example, a user captures an image of a check using a mobile device and sends the document image to a financial institution. Upon receiving the document image the electronic version of the document is uploaded to a server associated with a financial institution and configured to store a plurality of document images. In some embodiments, the second device may be associated with a website, such as a website server. To this extent, the document image to may be uploaded to an online banking site associated with the financial institution. The document image to may also be uploaded to database located on a server associated with the financial institution.

Document images may additionally be verified to ensure the integrity of the captured image. In some embodiments, verifying the integrity of a document image comprises verifying a document image has been generated for each page of the document received. For example, a ten page document may be received and in response to receiving the ten page document only eight document images are accounted for. The system may then generate an error indicating that the generated document images are incomplete. Verifying the integrity of a document image may also comprise verifying that the resolution of the document image meets a predetermined threshold. For example, an entities system may only be able to process images which are greater than 1000 pixel. To this extent, upon receiving each document image the system may verify that the image is greater than or equal to 1000 pixels. It should be noted that while a high image resolution may be necessary in ensuring a document is accurately processed, the imaged resolution may be later reduced prior to the storage of the image to aid in optimizing storage space.

Capturing an image of a document may further comprise associating a transaction ID with the document being captured. The transaction ID may be any alphanumeric identifier which is used to reference a particular document. The transaction ID may be user specific, document specific, location based, or any combination of the aforementioned. In some embodiments, the transaction ID is a parameter contained within the document itself. For example, in an instance where the document is a check the transaction ID may be the check number coupled with an identifier of the user's account. The system may determine the transaction ID to be associated with a document before or after an initial image has been captured of the document. In some embodiment, the transaction ID may be determined based at least partially on the document information.

At block 620 the method comprises processing the image of the document to collect document information. After the successful retrieval or capture of the image of the document, the apparatus may process the image of the document. The apparatus may capture individual pieces of document information from the image of the document. In some embodiments, the document information may be text. In other embodiments, the document information may be an image. Processing the document image may enable the apparatus to create a thumbnail version (a resized smaller version) of the image of the document at a lower resolution. In some embodiments, the thumbnail version of the image of the document may be created substantially simultaneously to the capture of the image of the document.

Processing the image of the document may first comprise converting the document to text form. The system may then extract information related to each parameter contained within the document. For example, in an instance that the processed document is a check, the check may be converted to a text format such that the contact information 305, the payee 310, the memo description 315, the account number and routing number 320, the date 325, the check number 330, the amount of the check 335, the signature 340, or the like can be obtained from the check.

Processing the image of the document to collect document information may further comprise using a character recognition algorithm. A captured image may be analyzed in order to decipher each character contained on the document image. Upon deciphering each character within the image the characters may be subsequently combined in order to obtained information of interest contained within the document. To this extent, in some embodiments, processing the image of the document to obtain document information may further comprise identifying information which is not of interest. For example, graphics contained on particular documents may be unimportant with respect to the business being conducted. The system may be configured to discard information which is identified as information which is not interest. This feature may ultimately aid in the reduction of storage size necessary to accommodate any particular document.

Processing the image of the document to collect document information may comprise capturing individual images of the document. To this extent a template may be used to process a document image. For example, many documents processed by financial institution are documents which use a standard form. To this extent the desired information to be collected is in the same position on each document. A template can then be used to selectively isolate information on a document. The template may overlay the document and isolate only the information which is of interest. In some embodiments, a series of templates are used to collect document information. For example, when processing a check image, the system may first apply a template overlay to the document image which isolates all fields except, the account number. Likewise, after the account number has been obtained, the system may apply a template overlay to the document image which isolates all fields except, the deposit amount. In some embodiments, when processing a document, the system is configured to only process information which is predetermined to be information of interest. For example, a financial institution may predetermine that they only want to process information related to the payee's name, contact information, deposit amount, and signature.

Processing the image of the document to collect document information may further comprise associating the collected document information with the transaction ID that was previously determined for the document. To this extent, when consistently referencing the document, the system may rely on the collected document information versus processing the document image itself multiple times. The transaction ID may be a parameter that is included in the document information or a parameter that is simply used to reference the document information. In some embodiments, the transaction ID may be page specific based upon the length of the document.

At block 630, the method comprises storing the document information. After the image of the document is processed, the apparatus may store the collected document information. Document information may be stored in various ways. The document information may typically be stored in an application server which can be accessed by the entity processing the document as well as the user associated with the document. Document information may be stored in different storage sites based on the time period in which the document was received. For example, documents that have been recently received may have their collected document information stored in a temporary storage site that can be quickly accessed by the processing entity. Documents that have not been recently received may have their document information archived in a long term storage site. In some embodiments, documents are stored in a temporary site for a predetermined period of time. After the predetermined time period has expired the document may be relocated to the long term storage site. Storing document images and/or information may additionally be based on the location in which the document was received. For example, a document that was received in STATE A, may be stored in the local storage of STATE A, seemingly how this region is more likely to initiate a request for the document information to be retrieved. In an instance that the document is needed by another entity that is either not located in STATE A or does not have access to the local storage of STATE A, the document may be uploaded to a remote server that is accessible by a plurality of entities independent of their location.

Storing document information may comprise separately storing the individual pieces of document information. The separately stored information may be associated with each other via data or metadata. One or more components of the document information may be individually stored in memory. For example, if a loan document is received, the system may store the signature pages separate from the pages which outline to terms of the loan. To this extent, any portion of the collected information may be individually referenced within the system without the need to render the original document image itself. Alternatively, the individual pieces of document information may be stored together and collectively referenced by the system.

Storing the document information may comprise storing the captured document image itself. In some embodiments, the apparatus may additionally store the original image of the check immediately after the image of the check is received. In some embodiments, the apparatus may additionally store a thumbnail version of the image of the document. Storing the document information may alternatively comprise storing a text version of the collected document information. In some embodiments, the system may only store information which is predetermined by the processing entity to be information of interest. The entity may reserve the right to determine how to process and/or how long to store the document information, image of the document, and/or the thumbnail version of the document.

Storing the document information may further comprise storing a system pointer which references the document information. Depending upon how the document information was stored one or more pointers may be used to reference a single document. For example, if one or more components of the document information have been separately stored from one another then a pointer may be additionally stored for each piece of information. Every item that is stored may be associated with a transaction ID regardless of whether the information is related to a single document.

At block 640 the method comprises receiving a request for the document information. The request for the document information may be associated with the transaction ID. In this way the system may reference the requested information with the use of the transaction ID. A request may comprise the transaction ID and the type of information which the user and/or entity want to retrieve. Request may be time sensitive such that the entity may request a time frame in which the requested information must be generated. Capturing the transaction ID for each request and/or retrieval attempt may be used as a means for verifying a particular individual has request and received relative document information. Request may additionally be associated with a plurality of transaction ID's. For example, if a customer wishes to investigate their account activity they may request for the system to generate every deposit and withdrawal slip associated with the user account. Alternatively, the plurality of transaction ID's may reference one document which comprises several components that are individually stored and each have a distinct transaction ID. To this extent, a plurality of transaction ID's may be used in requesting the document information. The request may comprise the transaction ID of each piece of information related to the document that was stored. In some embodiments, a request may be received which indicates that only a portion of the data should be retrieved. A request may also be received for the original document image to be rendered and not a system made recreation of the document information.

Receiving a request for document information may further comprise associating a request ID with the request for the document information. The request ID may be any alphanumeric identifier which is used to reference a particular request for document information. The request ID may be user specific, document specific, location based, or any combination of the aforementioned. In some embodiments, the request ID is a parameter contained within the document request itself. The request ID may be a subsidiary identification parameter related to the transaction ID.

At block 650 the document information is retrieved based at least partially on the request. Document information may be retrieved by mining the data stored in memory using the information specified in the request. For example, a request can indicate that the document image associated with a particular document be generated. To this extent, the requester may provide the transaction ID to aid in obtaining the requested data. The system may use the transaction ID as a reference point for retrieving the document information. In some embodiments, only a portion of the document information is retrieved. This is done in response to the request indicating that only a portion of the document information needs to be retrieved. For example, a loan officer may request a portion of the loan document be retrieved while reviewing a particular case. The loan officer may only be interested in the terms of the loan itself. To this extent the loan officer may generate a request which indicates the transaction ID associated with the loan and a request for the pages of the loan document which provide details of the loan terms. The system may then search, in memory, for the document information associated with the transaction ID and retrieve only the requested information. In some embodiments, transaction ID's may be page specific. To this extent if the loan officer is aware of the transaction ID associated with the desired pages, information may be retrieved solely with the use of that parameter. Retrieving only a portion of document information may comprise isolating a portion of the document image which contains the requested document information. Isolating a portion of the document image may include using templates, data extraction, and the like. In some embodiments, the system may need additional information to aid in retrieving document information. To this extent, if the information provided in the request is inadequate, the system may request that additional information be provided by the requester.

Retrieving document information based at least partially on a request for the document information may comprise referencing a pointer which points to the information of interest. In an instance that the request indicates that multiple pieces of individually stored document information be retrieved a plurality of pointers may be used to retrieve the information related to the request. In some embodiments, the pointer may create a temporary version of requested document information versus recreating the entire document image. The pointer may reference the document image in its entirety, a portion of the document image, the entire document information in text form, or a portion of the document information in text form.

Retrieving a portion of document information may comprise creating an image which represents only the portion of document information. In this way the created images can be referenced when similar and/or identical request are received. In some embodiments, the system uses images generated during previous request to provide document information of a current request. For example, when receiving a request the system may first analyze the request activity associated with the respective transaction ID. If it is determined that the information has been previously requested, the system may reference the previously generated image. In an instance that is it determined that the request is new and unique the system may generate a new image which represents the requested data. Analyzing the request may further comprise comparing the request to previous request contained within the activity log associated with the transaction ID. In some embodiment, the request may indicate that all of the document information associated with the document be retrieved. In such an embodiment, the system may reference the original document image or the document information, collected from the document image, in its entirety.

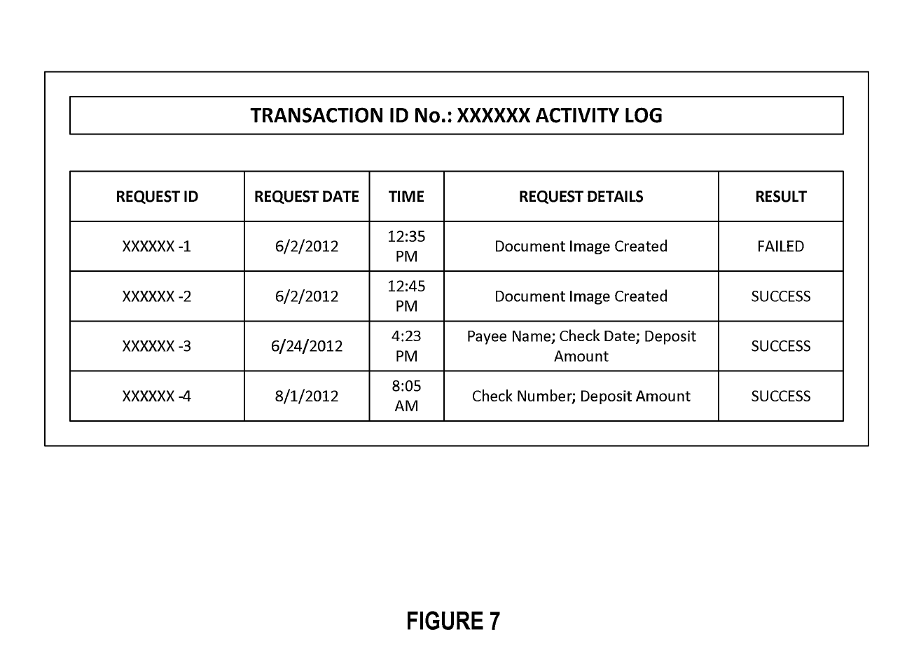

At block 660 the method comprises creating an activity log. The activity log may comprise a record of one or more request associated with a particular document. In some embodiments, the activity log is a chronological record of each retrieval attempt associated with a transaction ID. The activity log may comprise the request ID for each request for document information that is associated with the respective document and/or transaction ID. The activity log may contain the specific details of each request as well as any images generated in response to the request. As illustrated in FIG. 7, the activity log can comprise a plurality of parameter which detail one or more request associated with the transaction ID or a specific document. In the illustrated example, the activity log comprises the request ID for each request received, and the date and time the request was made. The activity log may also contain general data related to a document such as information related to when the document was created and stored. This may aid an entity in determining when a document was initially received by the entity. The activity log may additionally indicate the result of a particular request. For example, the activity log may record whether each retrieval attempt was a success of failure.

The activity log may aid in determining patterns associated with document retrieval and/or other financial behavior. In some embodiments, the activity log may be used as a means for auditing processes. To this extent, the activity log may be stored in a form that is a capable of being sent via email, text messaging, sms messaging and the like.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. An apparatus for image retrieval based on transaction identification, the apparatus comprising:
a memory;
a processor; and
a module stored in the memory, executable by the processor, and configured to cause said processor to:
capture, using an image capture device, an image of a tangible document, wherein the document is associated with a transaction ID;
collect document information included in the document image based at least partially on processing the image of the document;
store the document information, wherein storing the document information comprises storing a single system pointer which references both the collected document information and the captured image of the tangible document;
receive a request for the document information, wherein the request is associated with the transaction ID, and wherein receiving the request for the document information further comprises determining a request ID to be associated with the request for the document information;
retrieve the document information in response to the request, wherein retrieving the document information comprises referencing the system pointer, and wherein the system pointer references the document information such that the document information is retrieved without the captured image being recreated or processed each time a request for the document information is received; and
create an activity log, wherein the activity log comprises a record of one or more request for the document information associated with the transaction ID, wherein logging the transaction ID for the one or more requests provides verification that an entity has requested and received the retrieved document information, and wherein the activity log comprises the request ID of each request for document information that is associated with the tangible document and transaction ID.

2. The apparatus of claim 1, wherein the transaction ID is determined after the initial capture of the image of the document.

3. The apparatus of claim 1, wherein capturing the image of the document further comprises converting the document type to a predetermined electronic format.

4. The apparatus of claim 1, wherein the module is further configured to create the system pointer which references the document information.

5. (canceled)

6. The apparatus of claim 1, wherein retrieving the document information comprises retrieving a portion of the document information, wherein the request indicates a request for a portion of the document information.

7. The apparatus of claim 1, wherein storing the document information further comprises individually storing one or more components of the document information.

8. A method for providing image retrieval based on transaction identification, the method comprising:
capturing, using an image capture device, an image of a tangible document, wherein the document is associated with a transaction ID;
collecting, using a computer processing device, document information included in the document image based at least partially on processing the image of the document;
storing, in memory, the document information, wherein storing the document information comprises storing a single system pointer which references both the collected document information and the captured image of the tangible document;
receiving, using a computer processing device, a request for the document information, wherein the request is associated with the transaction ID, and wherein receiving the request for the document information further comprises determining a request ID to be associated with the request for the document information;
retrieving, using a computer processing device, the document information in response to the request, wherein retrieving the document information comprises referencing the system pointer, and wherein the system pointer references the document information such that the document information is retrieved without the captured image being recreated or processed each time a request for the document information is received; and
creating, using a computer processing device, an activity log, wherein the activity log comprises a record of one or more request for the document information associated with the transaction ID, wherein logging the transaction ID for the one or more requests provides verification that an entity has requested and received the retrieved document information, and wherein the activity log comprises the request ID of each request for document information that is associated with the tangible document and transaction ID.

9. The method of claim 8, wherein the transaction ID is determined after the initial capture of the image of the document.

10. The method of claim 8, wherein capturing the image of the document further comprises converting the document type to a predetermined electronic format.

11. The method of claim 8, the method further comprising creating the system pointer which references the document information.

12. (canceled)

13. The method of claim 8, wherein retrieving the document information comprises retrieving a portion of the document information, wherein the request indicates a request for a portion of the document information.

14. The method of claim 8, wherein storing the document information further comprises individually storing one or more components of the document information.

15. A computer program product for providing image retrieval based on transaction identification, the computer program product comprising:
a non-transitory computer-readable medium comprising a set of codes for causing a computer to:
capture, using an image capture device, an image of a tangible document, wherein the document is associated with a transaction ID;
process collect document information included in the document image based at least partially on processing the image of the document to collect document information;
store the document information, wherein storing the document information comprises storing a single system pointer which references both the collected document information and the captured image of the tangible document;
receive a request for the document information, wherein the request is associated with the transaction ID, and wherein receiving the request for the document information further comprises determining a request ID to be associated with the request for the document information;
retrieve the document information based at least partially on the request in response to the request, wherein retrieving the document information comprises referencing the system pointer, and wherein the system pointer references the document information such that the document information is retrieved without the captured image being recreated or processed each time a request for the document information is received; and
create an activity log, wherein the activity log comprises a record of one or more request for the document information associated with the transaction ID, wherein logging the transaction ID for the one or more requests provides verification that an entity has requested and received the retrieved document information, and wherein the activity log comprises the request ID of each request for document information that is associated with the tangible document and transaction ID.

16. The computer program product of claim 15, wherein the transaction ID is determined after the initial capture of the image of the document.

17. The computer program product of claim 15, wherein capturing the image of the document further comprises converting the document type to a predetermined electronic format.

18. The computer program product of claim 15, wherein the set of codes are further configured to cause a computer to create the system pointer which references the document information.

19. (canceled)

20. The computer program product of claim 15, wherein retrieving the document information comprises retrieving a portion of the document information, wherein the request indicates a request for a portion of the document information.

21. The apparatus of claim 4, wherein storing the document information comprises separately storing individual portions of the document information, and wherein creating the system pointer further comprises associating the system pointer with the transaction ID such that it references each individually stored portion of the document information.

22. The method of claim 11, wherein storing the document information comprises separately storing individual portions of the document information, and wherein creating the system pointer further comprises associating the system pointer with the transaction ID such that it references each individually stored portion of the document information.

23. The computer program product of claim 18, wherein storing the document information comprises separately storing individual portions of the document information, and wherein creating the system pointer further comprises associating the system pointer with the transaction ID such that it references each individually stored portion of the document information.
